(19) United States
(12) Patent Application Publication
(10) Pub. No.: US 2024/0116243 A1
(43) Pub. Date: Apr. 11, 2024

(54) DEVICE AND METHOD FOR SIMULTANEOUS ADDITIVE MANUFACTURING OF COMPONENTS COMPOSED OF DIFFERENT MATERIALS

(71) Applicant: KULZER GMBH, Hanau (DE)

(72) Inventors: Jochen SAGOLLA, Frankfurt (DE); Lars DIEZ, Hanau (DE)

(73) Assignee: KULZER GMBH, Hanau (DE)

(21) Appl. No.: 18/277,169

(22) PCT Filed: Feb. 14, 2022
(86) PCT No.: PCT/EP2022/053466

§ 371 Date: Aug. 14, 2023

(30) Foreign Application Priority Data
Feb. 15, 2021 (DE) 10 2021 103 511.2

(51) Int. Cl. B29C 64/182; B22F 10/12; B22F 12/30; B22F 12/49; B22F 12/55; B22F 12/90; B29C 64/135; B29C 64/232; B29C 64/236; B29C 64/245; B29C 64/255; B29C 64/277; B29C 64/336; B33Y 10/00; B33Y 30/00; B33Y 50/02

(52) U.S. Cl. CPC B29C 64/182; B22F 10/12; B22F 12/30; B22F 12/49; B22F 12/55; B22F 12/90; B29C 64/135; B29C 64/232; B29C 64/236; B29C 64/245; B29C 64/255; B29C 64/277; B29C 64/336; B33Y 10/00; B33Y 30/00; B33Y 50/02; B22F 2998/10

(57) ABSTRACT

Devices for the layer-by-layer generative production of at least one three-dimensional shaped part from at least two radiation-curable compositions are provided and comprise at least one radiation source and/or beam deflection device and at least one pressure trough with at least two process chambers openable at the top, wherein the at least two process chambers are arrangeable above the radiation source or a radiation deflection device, so that the curable compositions in the process chambers are exposable to radiation from below via the radiation source and/or the radiation deflection device. The devices further comprise a building platform having an underside which is exposable to rays from the radiation source, wherein the bottom of the pressure trough comprises at least partially a transparent material. Additionally, processes for producing at least one three-dimensional shaped part from at least two different curable compositions are provided.

The present invention relates to a 3D printer based on the principle of the SLA/DLP process.

3D printers based on the principle of the SLA/DLP (SLA: Stereo Lithography Apparatus) process can currently only produce shaped parts from one material. 3D printers available in the state of the art do allow the use of different materials. However, this requires the material in the print reservoir to be replaced or the complete reservoir including material to be replaced. This approach allows only a serial processing of the process steps. The device and the process of the invention are particularly effective in a CLIP process (Continous Liquid Interface Production)—i.e. in a continuous process in which a so-called “dead zone” is built up from which the shaped part can be built up. In this process, a “non-polymerizable zone (dead zone)” is chemically created between the contact surface of the shaped parts on the build platform and the transparent base, from which the shaped parts are produced from a curable composition in the CLIP process.

Therefore, it is an object of the present invention to provide an apparatus and method that allows simultaneous printing of different materials in the same 3D printer.

The problem is solved by a device for the layer-by-layer generative production of at least two three-dimensional shaped parts, each consisting of at least one separate composition curable by means of radiation, in particular two to n shaped parts, comprising
at least one radiation source and/or beam deflector suitable for head-over-head impingement of the curable compositions with beams, and
at least one pressure trough with at least two process chambers open at the top, in particular two to n-th process chambers, each suitable for receiving in each case one of the curable compositions, wherein the at least two process chambers are arrangeable or are arranged above the radiation source or a radiation deflection device, so that the curable compositions in the respective process chambers, in particular different process chambers, are subjectable to radiation from below via the radiation source and/or the radiation deflection device, and
a building platform, in particular having an underside which is exposable to radiation from the radiation source, suitable for bonding the respective shaped parts to be formed from the curable compositions in the at least two top open process chambers, wherein the bottom of the at least one pressure trough with the at least two process chambers facing the radiation source and/or radiation deflection device at least partially comprises a transparent material.

Preferably, the bottom is provided with a fluorine-containing coating or fluorine-containing film on the inner surface facing the process chambers. The bottom can be segmented and be a separate bottom for each process chamber. The bottom can thus be designed with special radiation filters for each process chamber depending on the radiation-curable composition. In an alternative, the bottom can comprise a transparent plate on which a silicone layer and/or film is arranged for each process chamber. The advantage of this segmentation is that, in the event of damage, only one foil in the affected process chamber needs to be replaced. The pressure trough can comprise two to n, with n equal to 3 to 500 process chambers, in particular 3 to 150, preferably 10 to 150, particularly preferably 50 to 250.

Alternatively, it may be preferred that one tray with a transparent bottom or transparent tray is inserted in each of one to n-th process chambers. The trays can be locked into place in the process chambers or magnetically fixed in the process chambers. Curable compositions may be placed in said trays. Alternatively, trays may be provided as sealed kits comprising curable compositions. Further, trays may be provided as a horizontal array of trays comprising one or different curable compositions as sealed kits.

With the apparatus and process according to the invention, one to n shaped parts per process chamber and, in each of the at least second to n-th process chambers, one to n shaped parts per process chamber can be produced simultaneously from each of the curable compositions by means of radiation curing. The particular advantage of the invention results from the arrangement of a pressure trough with two to n process chambers in a device with a radiation source emitting radiation over an area, in particular with a projection unit, for simultaneous radiation exposure of the bottom of the process chamber filled with a composition selected from one to n process chambers.

The device preferably comprises a device for homogenizing the beam quantity distribution of the radiation source and/or the beam quantity distribution of the beam deflection device, which serves to produce a homogenized beam quantity distribution and has an arrangement of a two-dimensional radiating radiation source, an area light modulator and an optical system, in particular a lens system forms the optical system. The device for homogenizing the beam quantity distribution is preferably provided below the exposure field on which the pressure trough can be arranged in the device. The device for homogenizing the beam quantity distribution is suitable for homogenizing the two-dimensionally radiating beam source and for imaging the beams only onto selected process chambers, in particular onto the process chambers filled with a composition. In a very particularly preferred device and method, simultaneous exposure of a selection of process chambers, in particular the process chamber filled with a radiation-curable composition, is possible.

The task of the present invention is solved in an alternative by an apparatus for the layer-by-layer generative production of at least two three-dimensional shaped parts, each from at least one separate composition curable by means of radiation, comprising
at least one radiation source and/or beam deflector suitable for head-over-head impingement of the curable compositions with beams, and
containing a pressure trough, optionally in an optionally at least one basin module, with at least two process chambers open at the top, each suitable for receiving a curable composition, and at least one reservoir comprising a supply of at least one curable composition, wherein the at least two process chambers are arrangeable or are arranged above the radiation source or a radiation deflection device, so that the curable compositions in the process chambers are exposable to radiation from below via the radiation source and/or the radiation deflection device, and
a building platform having an underside which is exposable to radiation from the radiation source, suitable for bonding the shaped part to be formed from the respective curable composition,
characterized in that the bottom of the pressure trough facing the radiation source and/or radiation deflection device with the at least two process chambers at least partially comprising a transparent material. Preferably, at least two to each process chamber are assignable a separate reservoir and optionally a separate basin module. In this way, quasi-continuous printing can be performed in the respective process chambers. For example, a reservoir and optionally a basin module is assignable to one or more process chambers in order to permanently print 3D shaped parts in the process chambers by means of radiation curing without the composition present in the process chamber being permanently exposed to radiation. By storing the curable composition in reservoirs, additional curable composition can be added to a process chamber as needed.

In one embodiment, a print well may be a part of a basin module of a 3D printer. A preferred print tray is inserted into a device without a basin module. The print trough contains—in particular separated by one or more separating plates—one or more process chambers in which the actual 3D printing process takes place. The separating plate can be reversibly fixable vertically in the bottom of the printing tray, in particular plug-in, magnetically fixable and/or snap-in, e.g. in transparent silicone lips, which can be arranged on the bottom of the printing tray. This allows each process chamber to be configurable in terms of size and can be adapted to the printing process. The number and size of the process chambers are thus variable. The print trough preferably comprises the entirety of the process chambers.

The bottom of the pressure trough is preferably made of a transparent material so that the radiation source, with whose beams curable compositions are cured, can be positioned below the bottom. The irradiation takes place through the bottom of the trough. Here, the bottom may preferably be provided as a continuous large irradiation window across all process chambers or a single irradiation window for each process chamber. Alternatively, the bottom of the tank can be formed by a transparent plate on which trays with transparent bottoms, preferably transparent bottoms made of transparent films, can be placed to form the process chambers.

The walls of the pressure trough and optionally engageable separation plates are preferably coated with silicone to provide effective sealing of the individual process chambers from each other so that different compositions can be filled into the process chambers. In one embodiment, the bottom of the pressure trough is 100% transparent radiolucent material. In particular, the transparent radiolucent material can be an inorganic glass, in particular quartz glass, or also a transparent polymeric material, such as polymethyl methacrylate (PMMA), polycarbonate (PC) or polyimide.

It is preferred that the two to n-th process chambers, in particular with n equal to 20 to 200, of the pressure trough are formed by vertical separating plates, optionally transparent separating plates, in the pressure trough.

Furthermore, it is preferred if the pressure trough with the bottom facing the radiation source and/or radiation deflection device is formed by at least one transparent
i) glass plate, wherein the at least one glass plate is optionally provided on the surface of the at least one glass plate facing the at least two process chambers with a coating, a silicone layer and/or a foil, or, wherein optionally a foil is arranged on the silicone layer, or
ii) polymer plate, wherein the at least one polymer plate is optionally provided with a coating, a silicone layer and/or a film on the surface of the at least one polymer plate facing the at least two process chambers, or, wherein a film is optionally arranged on the silicone layer, or
(iii) film, in particular at least one polymeric film, preferably a fluorine-containing polymeric film.

Preferably, the coating is an anti-stick coating, in particular the coating comprises fluorine-containing polymers, especially preferred are fluorine and polyalkylene oxide containing polymers. Further preferably, the glass is selected from SiO₂ glass, borosilicate glass, fused silica, annealed glass. A preferred polymer plate is formed from a transparent polymer comprising polycarbonate, polymethyl methacrylate (PMMA) or polyimide.

It is further preferred if the film is preferably a film permeable to gases, in particular nitrogen and/or oxygen. Particularly preferred films or coatings or also silicones comprise, as fluorine-containing polymers, polytetrafluoroethylene, fluorine-containing polyalkylene oxides or other partially fluorinated or perfluorinated hydrocarbons known to the skilled person and fluoroalkyl compounds containing partially fluorinated or perfluorinated oxygen atoms, in particular films permeable to nitrogen and/or oxygen.

According to an alternative, it is preferred if the bottom of the pressure trough or a bottom of the respective process chamber is formed by:
i) a glass plate with overlying film or a polymer plate, in particular the respective plate has a coating on the surface facing the process chambers, preferably an anti-stick coating, preferably a fluorine-containing coating,
ii) Film, in particular a sheet-like film of polymeric material, preferably a fluorine-containing polymeric film, preferably a fluorohydrocarbon-containing film, such as polytetrafluoroethylene-containing film, preferably the film is a gas-permeable membrane comprising fluorohydrocarbons. It is further preferred if the film is permeable to nitrogen and/or oxygen.

In particular, the bottom of the pressure trough can integrally comprise a first bottom in a first process chamber, a second bottom in a second process chamber, and an n-th bottom in n-th process chamber. Alternatively, the bottom of the pressure trough may be segmented, wherein the first, second through n-th bottoms may form the bottom of the pressure trough from individual segments. Preferably, the transparent bottom of the pressure trough is integral to the entire pressure trough. Likewise, it is preferred if the transparent bottom of the pressure trough integrally comprises the first, second to n-th bottoms of the process chambers.

Depending on the proportion of transparent material at the bottom of the pressure trough, at least one process chamber to several process chambers of the pressure trough can be irradiated simultaneously with a radiation source positioned below the bottom, so that in one embodiment the different curable compositions in the different process chambers can be cured simultaneously with the same radiation source. In another embodiment, an individual irradiation window is provided for each process chamber, in particular with a separate radiation source, preferably with a projection unit. Thus, a device for simultaneous additive manufacturing of components made of different curable compositions is provided in an advantageous manner.

3D printing (also 3D printing), also known as additive manufacturing, additive manufacturing (AM), generative manufacturing or rapid technologies, is a comprehensive term for all manufacturing processes in which material is applied layer by layer to create three-dimensional objects (workpieces). In this process, the layer-by-layer build-up is computer-controlled from one or more liquid or solid materials according to specified dimensions and shapes (cf. CAD). Physical or chemical hardening or melting processes take place during the build-up. Typical materials for 3D printing are plastics, synthetic resins, ceramics and metals.

Head-over-head irradiation of the curable compositions with jets means that the curable composition is irradiated with jets from below, through the pressure trough bottom, and thereby cured. This results in a bottom-side bond of the shaped part to be formed from the curable compositions to the underside of the build platform or underside of the forming shaped part. Such head-over-head impingement with radiation or beams are achievable, for example, by arranging the source of radiation or beams below the pressure well arrangement. Alternatively, it is also possible to mount a mirror arrangement below the pressure trough arrangement as a radiation deflection device, via which the radiation is suitably introduced through the transparent bottom of the pressure trough. Also, at least two, in particular a plurality of radiation sources and/or radiation deflection devices may be provided. In one embodiment, a radiation source and/or a radiation deflection device is associated with each process chamber.

By means of radiation exposure, the curable compositions can be cured, depending on the choice of starting components, e.g. under polymerization, polycondensation, polyaddition and/or thermal curing.

Radiation-curable compositions, such as those used in stereolithography, are well known to those skilled in the art and are also commercially available. These are, for example, monomer mixtures containing, for example, acrylates, which can be cured by radiation, in particular in the presence of activators and/or initiators, via a polymer reaction, usually a free-radical polymerization. These curable compositions can be used both in liquid and in viscous, for example pasty, form. The curable compositions used with the device according to the invention can differ, for example, in their type, composition and color or coloring (shades). Suitable curable compositions may, for example, be provided with fillers, colorants, flow improvers and/or other additives.

Radiation includes the light spectrum visible to humans as well as ultraviolet and infrared radiation.

Different curable compositions can also be deposited in the at least two process chambers open at the top.

A device according to the invention is preferably a device for photopolymerization, in particular according to DIN EN ISO/ASTM 52900, VPP Vat Photopolymerization.

In a further embodiment, it is provided that the device is one for stereo lithographically producing at least one three-dimensional shaped part from at least two curable compositions and/or that the apparatus is one for digitally light processing at least one three-dimensional shaped part from at least two curable compositions.

Stereolithography processes belong to the rapid prototyping processes. Rapid prototyping processes are three-dimensional printing processes. In this case, radiation is used to polymerize (harden) monomers or compositions comprising a mixture of monomers, preferably with UV radiation. Starting from a 3D model in STL format, this is possibly provided with a support structure, also called a support, in order to increase the stability in the bath on the build platform. The model thus obtained is then digitally divided into individual layers, the process is called slicing. The individual layers are read into a machine control system, where they are adjusted accordingly. The machine control system regulates the sequence of movements and the irradiation process.

Digital Light Processing (DLP, English) is a projection technology developed by the US company Texas Instruments (TI) and registered as a trademark, in which images are generated by modulating a digital image onto a light beam. In this process, the light beam is split into pixels by a rectangular array of movable micromirrors and then reflected pixel-by-pixel either into or out of the projection path. The heart of this technology, the component that contains the rectangular array (matrix) of mirrors and their control technology, is called a DMD
Digital Micromirror Device. DLP is also used in the industrial sector for additive manufacturing.

In a DLP process, a surface is irradiated via a DLP chip (digital light processing, a micromirror reactor) with LED technology and an optical power of 0.5 to 100 watts. The DLP process is only known as a static process as well as a scrolling process. The radiation source is not moved during the irradiation phase (static) and irradiates new resin layers to be polymerized in still images each time.

The device further comprises an arrangement comprising an area-emitting radiation source, an area light modulator, and the optics, which is preferably a lens system. The radiation source may comprise a UV laser or a projector. For example, the projector may be a projector with DLP (Digital Light Processor) technology from Visitech AS. Preferably, a micromirror reactor is used with DLP technology. The optical power of the UV radiation source is preferably in the range of 0.5 to 100 watts. Preferred wavelengths are in the range of 340 nm to 500 nm, in particular the UV-radiation source has maxima in the range of 340 nm to 500 nm.

Preferred micromirror reactors may include microscanners and area light modulators, preferably an area light modulator. A particularly preferred radiation source, especially beamers, comprises a matrix-shaped array of tiltable micromirrors arranged as a plurality of driveable micromirrors arranged in rows and columns. A preferred area light modulator is a digital micromirror device (DMD).

In a further embodiment, it may be provided that the bottom of the pressure trough facing the radiation source and/or radiation deflection device and having the at least two process chambers additionally comprises highly transparent silicone and a polymeric layer containing fluorocarbons in addition to the transparent material comprising glass, in particular quartz glass, wherein the glass is formed as a glass pane, wherein the highly transparent silicone is formed as a layer on the glass pane on the side facing away from the radiation source and/or radiation deflection device, wherein the polymeric layer containing fluorohydrocarbon is arranged as a porous membrane on the side facing away from the radiation source and/or radiation deflection device on the highly transparent silicone layer.

As a result, the bottom of the pressure trough is permeable to the radiation. In one embodiment, the entire pressure trough bottom constitutes an irradiation field. In another embodiment, an irradiation field is provided for each process chamber of the pressure trough.

Quartz glass, also known as silica glass, is a glass which, in contrast to the more common glasses, does not contain any admixtures of soda or calcium oxide, i.e. it consists of pure silicon dioxide (SiO₂).

Silicones (also silicones), chemically more precisely poly(organo)siloxanes, is a name for a group of synthetic polymers in which silicon atoms are linked via oxygen atoms. Molecular chains and/or networks can occur. The remaining free valence electrons of the silicon are saturated by hydrocarbon radicals (usually methyl groups). Silicones thus belong to the group of organosilicon compounds. Because of their typically inorganic skeleton on the one hand and the organic radicals on the other, silicones occupy an intermediate position between inorganic and organic compounds, especially between silicates and organic polymers. In a sense, they are hybrids and exhibit a unique range of properties unmatched by any other plastic.

Highly transparent silicones are a special type of silicone elastomers that are used primarily in the optical sector. They belong to the LSR (liquid silicone rubber) materials, which are characterized above all by their low viscosity, and thus the possibility of processing the silicone by injection molding. In addition to the types that can be injection molded, there are also those that are suitable for potting. These have an even lower viscosity.

The greatest advantage for optical applications is offered by the silicone in terms of its resistance behavior. For example, it remains stable over a wide temperature range (−40° C. to +150° C.), on the one hand in its mechanical behavior, and on the other hand also in its optical behavior, i.e. compared to other plastics, silicone does not yellow over time. In optical applications in particular, yellowing must be avoided at all costs, as this leads to severe functional impairment and even functional failure. Another advantage of silicone over other materials is its elasticity. This can be exploited in headlamps, for example, to influence light conduction by deformation and thus generate dynamic bend lighting, among other things.

Furthermore, optical components made of silicone are significantly lighter than their glass counterparts due to their lower density. Silicone also offers manufacturing advantages. The processes are easier to handle, low cycle times can be realized and production can be carried out to very tight tolerances. In addition, the flow behavior of the material allows very complex geometries to be molded.

The polymeric layer containing fluorocarbon comprises polytetrafluoroethylene (abbreviation PTFE, occasionally also polytetrafluoroethene), which is an unbranched, linear, semi-crystalline polymer of fluorine and carbon. PTFE belongs to the class of polyhaloolefines, which also includes PCTFE (polychlorotrifluoroethylene). It belongs to the thermoplastics, although it also has properties that require processing more typical of thermosetting plastics.

In a further embodiment, the at least two process chambers may be separated from each other by at least one separating plate (partition wall), wherein the at least one separating plate is at least partially coated with a fluorine-containing coating and/or with silicone, wherein in particular the walls of the pressure trough are coated on the inside with a fluorine-containing coating and/or with silicone, so that the inner walls of the at least two process chambers each have a fluorine-containing coating and/or silicone layer.

By coating the walls of the process chambers with silicone, the curable mixtures can advantageously be detached from the walls of the process chambers after completion of the three-dimensional object.

Accordingly, the pressure trough arrangement may have a plurality of process chambers, in particular having substantially square or rectangular cross-sectional bottom surfaces, with adjacent process chambers preferably being separated from each other by a common partition.

In a further embodiment, it is provided that the at least one separating plate is reversibly engageable, in particular vertically, in the pressure trough.

As a result, the individual process chambers can be configured individually in terms of size in an advantageous manner. The number of process chambers is variable. Adaptation can be made to the shaped part to be printed. Process chamber and part-building platform can be assigned to each other. In one embodiment, the bottom of the pressure trough has sealing means, in particular, transparent silicone lips, rubber seal, sealing tape and/or flexible plastic, into which the separating plates can be pushed vertically. The sealing means serve to seal the separating plates at the bottom of the pressure trough.

In another embodiment, the build platform is segmented into punches, wherein the punches are movable, in particular along their longitudinal axis, in particular in the direction of the radiation source and/or beam deflector.

In an alternative, the build platform can be segmented into punches, with one punch being assigned to each process chamber. The punches can be static or manually movable along the z-axis, in particular in the printing direction of the material buildup. Likewise, in an alternative, the punches can be digitally controlled and movable along the z-axis by means of e-motors. Likewise, the build platform can be segmented and assembled for the application. In this case, one segment of a build platform can be individually selected for each process chamber and the selected segments can be assembled to form a build platform. Thus, it is also an object of the invention to provide a build platform that is composed of build platform segments and, in particular, can be individually assembled for different printing processes.

In this way, several build platforms can be realized simultaneously in an advantageous manner, each of which is matched to the size and shape of the respective process chambers.

Different compositions, i.e. different materials, can be cured simultaneously on the various part-building platforms in the associated process chambers. The shaped part to be formed from the different curable compositions is bonded simultaneously to the underside of the different part-building platforms in each process chamber if the irradiation times of the process chambers are identical.

The punch-like platform units in the head-over-head exposure device of the invention advantageously provide an automatic ejection system by selectively retracting or extending the individual punches of the build platform for detaching the printed object.

The number of punches can be n=2 to, for example, n=100 or n=200.

In this context, “movable” means that the punches can be moved down (toward the bottom of the pressure trough) or up (away from the pressure trough) or tilted from the build platform plane.

In a further embodiment, it is provided that each of the movable punches is individually controllable by a processor or at least one group of punches is individually controllable by a processor.

Each of the punches is individually controllable independently of the other punches. In one embodiment, the punches are arranged in a matrix and the punches are controlled via a matrix control. In this case, the control of a punch relates to the extent to which a punch is moved out of a defined zero position into a position calculated from the STL data, and thus derivable from the CAD data of the 3D model.

The device according to the invention for the layer-by-layer generative production of three-dimensional shaped parts further generally comprises a data memory for storing data, in particular CAD data, which represent a three-dimensional object. Such data memories and the implementation of suitable data sets for three-dimensional objects in these data memories are known to the skilled person.

In another embodiment, each of the movable rams has a motor, actuator, and/or gear drive.

In this way, it is advantageously possible to convert a single control of a punch into a mechanical movement of the punch. The individual punch can thus either be moved up and down along an axis or, in a further embodiment, be set at an angle.

In a further embodiment, it is provided that a first group of punches is assignable to a first process chamber, a second group of punches is assignable to a second process chamber, and an n-th group of punches is assignable to an n-th process chamber.

Each process chamber can thus be assigned a specific part-building platform (group of punches). A different curable composition, i.e. different material, can be arranged in each process chamber. Thus, a device for simultaneous additive manufacturing of components made of different materials is provided in an advantageous manner.

In a further embodiment, it is provided that the first group of punches with their front sides facing the radiation source and/or radiation deflection device form a first underside of the build platform, the second group of punches with their front sides facing the radiation source and/or radiation deflection device form a second underside of the build platform, and the n-th group of punches with their front sides facing the radiation source and/or radiation deflection device form an n-th underside of the build platform. Thereby, it is preferred if the first group of punches with first underside is reversibly movable into the first process chamber, in particular, the first group of punches can be vertically movable, preferably reversibly, towards the bottom of the first process chamber. Furthermore, it is preferred if the second group of punches with second underside is reversibly movable into the second process chamber, in particular vertically, preferably reversibly, towards the bottom of the second process chamber, and preferably also the n-th group of punches with n-th underside is reversibly movable into the n-th process chamber, in particular vertically towards the bottom of the n-th process chamber, wherein the first, second to n-th process chambers are arranged in the at least one pressure trough. It is further particularly preferred if each group of punches can be controlled individually.

wherein it is further preferred that a first curable composition at the first underside is curable by means of head-over-beam impact and is suitable for bonding the shaped part to be formed from the first curable composition, in particular from the polymerized composition, wherein a second curable composition on the second underside is radiation-curable by means of head-over-head impact and is suitable for bonding the shaped part to be formed from the second curable composition, and wherein an n-th curable composition on the n-th underside is radiation-curable by means of head-over-head impact and is suitable for bonding the shaped part to be formed from the n-th curable composition. Thereby, the bonding of the cured respective first, second or n-th composition to form the respective first, second or n-th shaped part can be performed simultaneously or sequentially.

This allows components of the shaped part to be formed from different compositions to be additively manufactured simultaneously or sequentially in the different process chambers.

According to a further alternative, the build platform with first group of punches, second group of punches to n-th group of punches or a build platform with one punch each, in particular for one process chamber each, can be controlled rotatably or in x,y plane, i.e. horizontally, via the pressure trough in order to control one punch, in particular per process chamber, or a group of first to n-th punches, in particular per process chamber, along the x,y plane. Thus, more than one specific area of a partial build platform (group of punches) are assignable to a process chamber. Alternatively, the pressure trough, and in particular different process chambers, are assignable to specific areas of the part platform along the x,y plane. In this way, moldings of different radiation-curable composition can be built.

The present invention is based on the knowledge that by using a pressure well arrangement containing two or more process chambers under head-over-head impingement with radiation through a transparent pressure bottom plate, arbitrarily composed three-dimensional shaped parts are obtainable generatively. In this process, curable compositions are selectively cured layer-by-layer using generative mask exposure. The respective different shaped parts can be made from at least two different curable compositions. Depending on the choice of curable compositions, these can generate different material properties and/or color impressions in the final product in the cured state. It is thus possible to reproduce the slightest differences in color, making very natural-looking dental products accessible, for example. Color settings can no longer be adjusted by the color setting of one curable composition alone, but by the interaction of two or more curable compositions.

In this context, “face” means the smallest side surface of a cuboid punch which faces the radiation source.

In a further embodiment, the first group of punches is provided with their first front sides in the direction of the radiation source and/or beam deflection device in the moved state on the first underside of the building platform to span a first three-dimensional surface profile, wherein the second group of punches with their second front sides in the direction of the radiation source and/or beam deflection device in the moved state on the second underside of the building platform span a second three-dimensional surface profile, and the n-th group of punches with their third front sides in the direction of the radiation source and/or beam deflection device in the moved state on the third underside of the building platform span a third three-dimensional surface profile.

Different partial profiles of the shaped part to be produced can thus be additively manufactured simultaneously in the different process chambers, with different materials being arranged as the starting substance in the different process chambers. For example, “overhangs” of a shaped part made of different materials can be printed simultaneously.

The three-dimensional surface profile is calculated from the STL or CAD data of the 3D model of the shaped part to be produced and realized by individually controlling and moving the punches from a defined zero position.

In one embodiment, the radiation source is equipped with a projection unit, in particular based on DLP, LCD mask exposure as well as VPP with laser spot exposure.

The preferred radiation source is the LUXBEAM® RAPID SYSTEM (LRS) from Visitech AS. The LUXBEAM® RAPID SYSTEM (LRS) is a DLP®-based stereo lithography subsystem for high-resolution additive manufacturing of parts. The LRS can be configured for, among other things, still image projection typically used in rapid prototyping/manufacturing. The LTR series consists of projectors with different resolutions in combination with a selection of lenses. The LRS supports batch production of many similar parts at high speed. The LRS takes advantage of a moving photo head to create a large build area and enables smart features such as Subpixelation (SPX) to improve resolution and Pixel Power Control (PPC) to provide the same amount of power to each pixel in the resin. The system features an advanced, digitally controlled UV LED radiation source that, combined with robust and reliable DLP® technology, provides a system with long life and low maintenance costs. The LRS is configurable and available in single or multiple head configurations to meet throughput and installation space requirements in the press. Already proven and reliable, the LRS is a plug-and-play system/module. The system is configurable with various high power UV LED options as well as a choice of dedicated UV projection lenses.

It can be provided that the unexposed pixels are defined by a mask stored for the control of the radiation source, in particular a programmable mask, in that certain light points of the radiation source always remain switched off. A mask according to the invention corresponds to a motif of the switched-off light points of the radiation source, wherein the motif is represented in the irradiation field as non-exposed pixels, in particular as a static motif of non-exposed pixels.

By means of the deposited mask, it is achieved in the simplest way that the light intensity is reduced in certain areas of the exposure field. This mask can then be used to achieve homogenization of the exposure field, in particular homogenization of the light intensity of the exposure field, especially preferably homogenization in the temporal integral of the light intensity of the exposure field.

As an alternative to the use of a mask with a background, it is also possible to define the unexposed pixels by blackening the micromirrors or by using an area light modulator with gaps in the lineup of micromirrors or by redirecting the light points through the micromirrors.

In a further embodiment, it is provided that the device for homogenizing the light quantity distribution in the exposure field has an area light modulator which has a plurality of controllable tiltable micromirrors arranged in rows and columns, in which the rays of a two-dimensionally radiating radiation source are imaged via an optical system and an irradiation field of the imaged radiation source is imaged on a projection surface, a number of pixels increasing towards the center of the irradiation field not being exposed, so that in the time integral a homogenization of the light intensity of all pixels exposed on the projection surface is achieved.

The projection surface is preferably formed by the transparent bottom of the pressure trough or, preferably, by the part of the bottom of the respective process chambers used.

Hereby, a particularly well-suited method is provided, with which specific intensity deviations of certain radiation sources, such as beamer types or individual beamers, can also be compensated in a simple manner.

In optics, a projection surface is the surface (often a projection plane) onto which an original image is imaged (projected) by rays.

Area light modulators consist of an array of micromirrors on a semiconductor chip, with the number of mirrors currently varying from several hundred to several million mirrors depending on the application. In most cases, a highly integrated application-specific electronic circuit (ASIC) is used as the basis of the component architecture to enable individual analog deflection of each micromirror. The individual mirrors, which vary in number and size per chip depending on the application, can be individually tilted or lowered to create a two-dimensional pattern that can be used to project defined structures, for example.

In addition, a process for producing at least one three-dimensional shaped part, in particular at least two three-dimensional shaped parts, from at least one separate radiation-curable composition in an apparatus is claimed, in particular for producing at least two three-dimensional shaped parts from at least one separate radiation-curable composition per shaped part, comprising the steps:
A) Providing a device with a pressure trough with at least two process chambers open at the top, in particular two to n process chambers, wherein the bottom of the pressure trough with the at least two process chambers at least partially comprises a transparent material, wherein at least a first process chamber of the at least two process chambers open at the top is filled with a first composition curable by means of radiation,
optionally filling the second process chamber of the pressure trough open at the top with a second radiation-curable composition, optionally filling further process chambers, in particular filling the n-th process chamber of the pressure trough open at the top with an n-th radiation-curable composition; and
B) a) relative, in particular vertical, movement of a first underside of the building platform and a first bottom of the first process chamber towards one another, so that the first underside or a first contact surface of the at least one forming shaped part attached to this underside comes into contact with a first curable composition present in the first process chamber or is at least partially immersed in it, wherein in particular a polymeric layer or film containing fluorocarbon is arranged at the first bottom or is part of the first bottom, in particular the polymeric layer or film containing fluorocarbon is replaceable, preferably the first bottom or the first contact surface of the at least one forming shaped part is spaced from the first bottom only by a defined layer of the first curable composition,
b) first curing a first layer on the first underside of the build platform or on the first contact surface to the at least one forming shaped part present first curable composition by means of head-over-head impingement with beams through the first bottom comprising a transparent material of the first process chamber,
c) relative moving away from each other of the first underside and the bottom of the first process chamber, in particular to wet a further contact surface of the at least one forming shaped part with the first curable composition present in the first process chamber, preferably the further contact surface or the at least one shaped part is spaced from the first bottom only by a defined layer of the first curable composition,
d) Repeat steps a) to c) until the three-dimensional shaped part is completed, and
C) optionally wherein at least one second process chamber of the at least two process chambers open at the top, in particular of the two to n-th process chamber, is filled with a second composition curable by means of radiation, in particular as the second to n-th process chambers are each filled with a separate radiation-curable composition,
a) relative, in particular vertical, movement of a second underside of the building platform and a second bottom of the second process chamber towards one another, so that the second underside or a first contact surface of the at least one forming shaped part attached to this underside comes into contact with a second curable composition present in the second process chamber or is at least partially immersed in it, preferably the second underside or the first contact surface of the at least one shaped part is spaced apart from the second bottom only by a defined layer of the second curable composition,
b) first curing a first layer on the second underside of the build platform or on the first contact surface to the at least one forming shaped part present second curable composition by means of head-over-head impingement with beams through the second bottom comprising a transparent material of the second process chamber,
c) moving the second underside and the second bottom of the second process chamber relatively away from each other, in particular to wet a further contact surface of the at least one forming shaped part with the second curable composition present in the second process chamber, preferably the further contact surface or the at least one shaped part is spaced from the second bottom only by a defined layer of the second curable composition,
d) Repeat steps a) through c) in C) until the at least one three-dimensional shaped part is completed.

Defined layers of the radiation-curable compositions are in particular layers of 5 to 250 micrometers, preferably layers of 20 to 100 micrometers.

In the process according to the invention, at least two to n shaped parts can be produced in two to n process chambers from at least two different radiation-curable compositions.

Therefore, a process for the production of at least two three-dimensional shaped parts from at least one separate composition curable by means of radiation in an apparatus with a pressure trough according to the invention is claimed, which comprises the above-mentioned steps. Here, two shaped parts are produced in one of the process chambers of the pressure trough, while the remaining process chambers are not exposed to radiation. In such a process, the following step thus takes place:
by means of head-over-impact with jets through the first bottom comprising a transparent material of the first process chamber, at least two moldings being produced in B). The subsequent step in C), in particular b), is not carried out in this variant: by means of head-over-impact with beams through the second bottom of the second process chamber comprising a transparent material. In this process variant, the sequence of steps in C) is optionally a) and optionally b), optionally c) optionally d), wherein if the at least one second process chamber of the at least two process chambers open at the top, in particular the two to n-th process chamber, is filled with a second composition curable by means of beams, in particular as the second to n-th process chamber is filled with a separate beam-curable composition in each case,
this process chamber is not exposed to radiation through the bottom. This can be done by not exposing the bottom to light or by covering the bottom from below.

Particularly preferred is a process for the production of at least two three-dimensional shaped parts from at least one separate radiation-curable composition each in an apparatus with a pressure trough according to the invention, comprising the steps mentioned. Here, at least two shaped parts are produced in at least two different process chambers of the pressure trough. Alternatively, two to n shaped parts are producible in two to n process chambers. The two to n shaped parts can also form groups of shaped parts that are printed in groups in two to n process chambers.

Alternatively, at least two to n shaped parts can be produced in the process according to the invention in only one of the two process chambers of the pressure trough according to the invention which are open at the top and have at least two process chambers open at the top. It can be useful to use the pressure trough according to the invention in this constellation as well and to cover the second to n-th process chambers, which may not be used, on the underside in a radiation-impermeable manner, so that radiation-curable compositions present in the second to n-th process chambers can be used later in another printing process. Covering the radiation-curable composition without decanting the composition can have the advantage that less composition is consumed by constant decanting. Therefore, this approach is more economical and minimizes the consumption of composition. According to the invention, the device can be used in a CLIP process and the process can be a CLIP process.

Optionally, processes B) or C) for the production of n-th shaped parts can be carried out in n-th process chambers of the pressure trough that are open at the top and are made of a composition that can be cured by means of n-th jets.

According to an alternative, it may be preferred if, in step c), the moving away from each other takes place in such a way that the first underside of the build platform or a forming part present thereon is no longer in contact, at least in some areas, with the first curable composition in the first process chamber and/or the first bottom of the first process chamber. The aforementioned step c) comprises the steps c) in A) and/or B) each independently.

Likewise, two to n shaped parts can also be built up from different radiation-curable compositions by using the pressure trough according to the invention with at least two process chambers. This is possible by either moving the build platform in x,y-plane above the process chambers correspondingly above other process chambers or moving the pressure trough correspondingly below the build platform correspondingly in x,y-plane.

Thus, the method according to the invention may also comprise c) relatively moving away from each other the second underside and the second bottom of the second process chamber so that the first underside of the build platform or a forming part present thereon is at least regionally no longer in contact with the first curable composition in the first process chamber, in particular until the first underside of the build platform or a forming part present thereon is movable in x,y-plane over the process chambers or the process chambers, i.e. the pressure trough is freely movable in x,y-plane thereunder i.e. the pressure trough is freely movable in x,y-plane below. Assigning the first underside of the building platform or a forming part present thereon to a second process chamber and carrying out C) a) and in particular b) c) and optionally d).

It is preferred if the bottom of the pressure trough has a fluorine-containing polymer coating or a fluorine-containing polymer film as transparent material on the surface facing the at least two process chambers. Preferably, the fluorine-containing polymeric film is replaceable.

Preferably, a pressure trough can be provided, the bottom of which is formed of transparent material. The bottom of the pressure trough preferably comprises at least one or more plates made of borosilicate glass, quartz glass, annealed glass, polymers which are optionally provided with silicone or a film on the surface facing the respective process chambers.

Preferably, in step a), the method in B) may comprise step a2): Moving a first group of punches from a first underside of a build platform to a first position for forming a first three-dimensional surface profile by means of the first end sides of the first group of punches facing the radiation source, wherein initially the first underside faces the bottom of the first process chamber. Analogous procedure can be followed in C) with second and n-th group of punches with second and n-th underside for forming a respective surface profile in second to n-th process chamber.

Furthermore, the invention relates to a process for producing at least one three-dimensional shaped part from at least two different curable compositions, the process comprising the steps of:
A) Providing a device according to any one of the preceding claims;
optionally i) providing a pressure trough with snap-in separating plates, in particular reversibly snap-in separating plates, preferably in the apparatus;
ii) Dividing the pressure trough into a first, second and n-th process chamber by means of reversible snap-in positioning of the separating plates within the pressure trough;
optionally filling the first process chamber of the pressure trough, which is open at the top, with a first composition which is curable by means of jets;
optionally filling the second process chamber of the pressure trough, which is open at the top, with a second composition which is curable by means of jets;
optional filling of the n-th open-topped process chamber of the pressure trough with an n-th radiation-curable composition;
a.1) Moving a first group of punches from a first underside of a build platform to a first position to form a first three-dimensional surface profile by means of the first faces of the first group of punches facing the radiation source, wherein initially the first underside faces the bottom of the first process chamber coated with a polymeric layer containing hydrofluorocarbons;
a.2) relative, in particular vertical, movement of the first underside of the building platform and the bottom of the first process chamber coated with the fluorohydrocarbon-containing polymeric layer towards one another, so that the first underside or a forming shaped part attached to this underside comes into contact with a first curable composition present in the first process chamber or is at least partially immersed in it, wherein in particular a polymeric layer or film containing fluorocarbon is arranged at the first bottom or is part of the first bottom, in particular the polymeric layer or film containing fluorocarbon is replaceable, preferably the first bottom or the shaped part is spaced from the first bottom only by a defined layer of the first curable composition;
b) first curing a first layer on the first underside or on the first contact surface to the forming shaped part present first curable composition by means of head-over-head impingement with jets through a first bottom comprising a transparent material of the first process chamber;
c) moving the first underside and the bottom of the first process chamber relatively away from each other so that the first underside of the build platform or a forming shaped part present thereon is no longer in contact with the first curable composition in the first process chamber and/or the first bottom of the first process chamber, at least in some areas. Steps a.1, a2, b and c can be repeated as step d until the shaped part has been completely formed.

In one embodiment, the method comprises the step of: e) removing the shaped part from the first underside of the build platform by moving the punches of the first group to a second position. The same procedure can be used for the second to the n-th shaped part.

In one embodiment, the step sequence a.1) to c) is repeated at least once, preferably n times, before proceeding to step e). The step sequences a.1) to c) and e) can each be carried out independently of one another in A) and/or B). For all statements mentioned in connection with this method, “at least once, preferably n times” may preferably comprise “at least twice to preferably n times”.

In a further embodiment, it is provided that this represents a method for stereolithographically producing at least one three-dimensional shaped part and/or represents such a method for digitally light processing at least one three-dimensional shaped part from at least two curable compositions.

This advantageously provides methods for the simultaneous additive manufacturing of components made of different materials.

The invention also relates to the use of the shaped parts obtained according to the process as a dental shaped part for dental restoration, as a dental prosthesis, as an auxiliary part for a dental prosthesis, as a prosthesis, in particular a bone prosthesis, or a component thereof, or as a hearing aid housing.

The invention further relates to a pressure trough for the device according to the invention. In addition, it is an object of the invention to comprise a kit comprising a pressure trough according to the invention and the device. It may also be useful to associate a pressure trough or a process chamber with a tubular bag having a metering tube with a respective process chamber as a metering system.

The invention further relates to an orthodontic appliance for making a dental splint, using the device according to the invention.

Further details, features and advantages of the invention will be apparent from the drawings, as well as from the following description of preferred embodiments based on the drawings. The drawings merely illustrate exemplary embodiments of the invention, which do not restrict the essential idea of the invention.

### FIGURE DESCRIPTION

FIGS. 1a and 1b show a device 1 for the layer-by-layer generative production of at least one three-dimensional shaped part 2 from at least two radiation-curable compositions 3a, 3b.

FIG. 2 shows a top view of the pressure trough 6 with the pressure trough 6 divided into process chambers 7a, 7b, 7c and 7d of the same size (FIG. 2a) and into process chambers 7a, 7b, 7c and 7d of different sizes (FIG. 2b).

FIG. 3 shows a top view of the pressure trough 6 with the pressure trough 6 divided into process chambers 7a, 7b, 7c and 7d of equal size, each process chamber having its own irradiation window (FIG. 3a) or the process chambers sharing a large common irradiation window.

FIG. 4 shows the building platform in each case laterally (top) and in plan view (bottom), whereby in FIG. 4a four punches are formed, whereby in FIG. 4b n punches are formed.

### EMBODIMENTS OF THE INVENTION

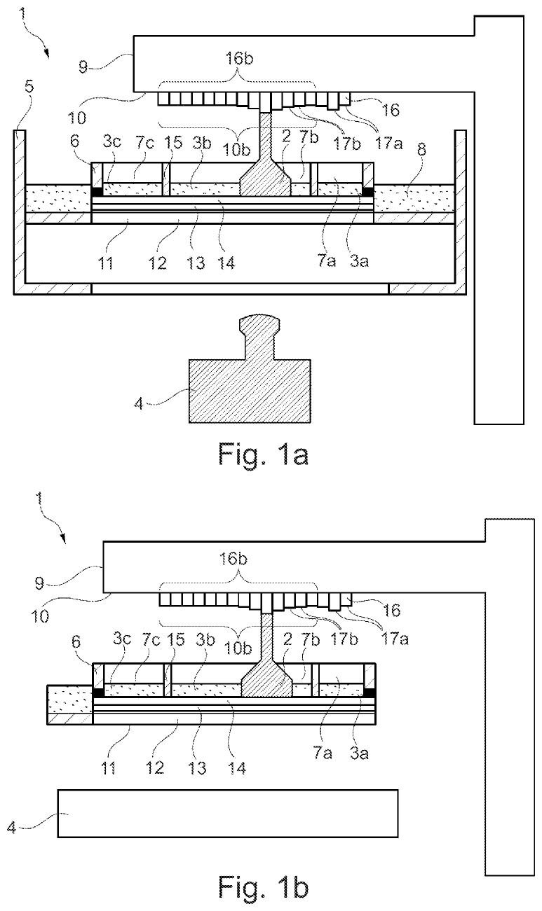

FIG. 1a shows a device 1 for the layer-by-layer generative production of at least one three-dimensional shaped part 2 from at least two radiation-curable compositions 3a, 3b. The device comprises at least one basin module 5 with a pressure trough 6 and optionally a reservoir 8 (FIG. 1b). The optional reservoir 8 (FIG. 1b) of the basin module 5 contains a supply of curable compositions 3. In alternatives, the composition can escape in a free space between the separating plate and the build platform during the printing process. The pressure trough 6 can be divided into process chambers 7a, 7b, 7c—at least into two, preferably into 100, particularly preferably into 200 process chambers—by means of engageable, in particular vertically arranged separating plates 15 optionally reversibly engageable separating plates, in which the actual additive manufacturing takes place. The process chambers 7a, 7b, 7c are sealed against each other by a silicone coating of the walls and the bottom 11 of the process chambers, so that a different curable composition 3a, 3b, 3c can be filled into each process chamber. The bottom 11 of the pressure trough 6 is designed with one to several layers and comprises—from bottom to top—a first glass layer 12, in particular quartz glass layer or a PMMA plate, optionally a second transparent silicone layer 13 and optionally a third fluorocarbon-containing polymeric layer 14 and is thus permeable to radiation.

A radiation source 4 and/or beam deflector for curing the curable compositions in the process chambers can thus be placed below the pressure well bottom 11 so that head-over-head impingement of the curable compositions 3 with beams can occur. The preferred radiation source is the LUXBEAM® RAPID SYSTEM (LRS) from Visitech AS, which is a DLP®-based stereo lithography subsystem for additive manufacturing.

Irradiation takes place through the pressure trough bottom. Either a large window can be provided across all process chambers 7a, 7b, 7c or an individual irradiation window for each process chamber.

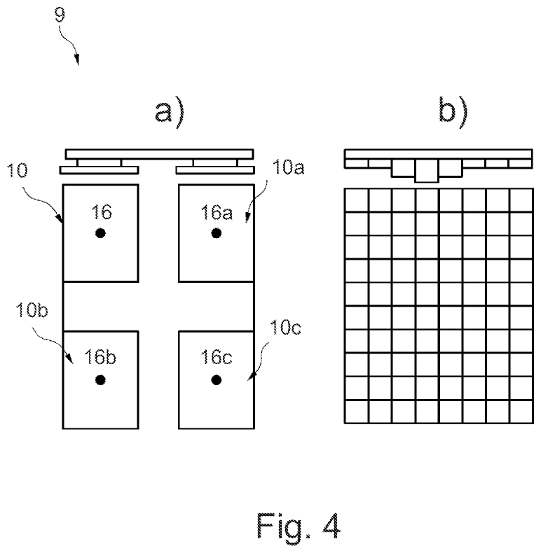

Groups of punches 16a, 16b, 16c of a building platform 9 can be assigned to the individual process chambers 7a, 7b, 7c. The punches 16a, 16b, 16c can be moved out of the plane of the build platform 9 by means of a motor, each individual punch being individually controlled by a microprocessor. The punches 16a, 16b, 16c each form an underside 10a, 10b, 10c facing the radiation source 4 (see FIG. 4). The shaped part 2 to be produced is bonded to this during the curing process. Each group of punches 16a, 16b, 16c forms a respective three-dimensional surface structure in the respective process chamber 7a, 7b, 7c with their front sides 17a, 17b, 17c facing the radiation source 4. The three-dimensional surface structure can be derived from the STL or CAD data of the 3D model of the shaped part to be produced.

The punch-like platform units advantageously result in an automatic ejection system by selectively retracting or extending the individual punches 16 of the building platform 9 for detaching the printed object/shaped parts 2.

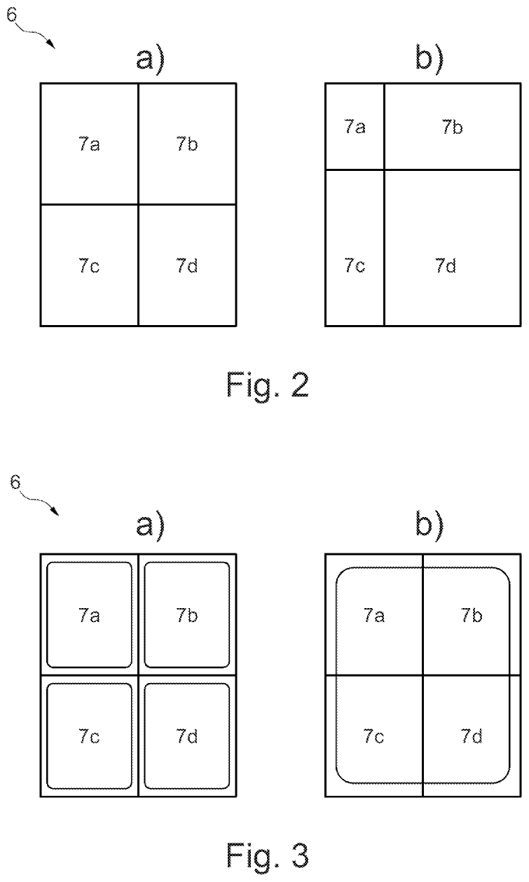

FIG. 2 shows a top view of the pressure trough 6 with division of the pressure trough 6 into process chambers 7a, 7b, 7c and 7d of equal size (FIG. 2a) and into process chambers 7a, 7b, 7c and 7d of different size (FIG. 2b). Accordingly, the pressure trough arrangement may have a plurality of process chambers, in particular with substantially square or rectangular cross-sectional bottom area, wherein adjacent process chambers are preferably separated from each other by a common separating plate. The separating plates of the process chambers 7a, 7b, 7c and 7d can be removed from the pressure trough 6 and re-inserted vertically, preferably in transparent silicone lips (not shown), into the pressure trough 6 with the same or a different arrangement. The resulting respective size of the formed process chambers 7a, 7b, 7c and 7d can be adapted to the size of the shaped part to be additively manufactured. The separating plates preferably have a silicone coating to ensure effective sealing of the respective process chambers. A different curable composition can be deposited in each process chamber. The actual printing process takes place in the process chambers 7a, 7b, 7c and 7d. If each of the process chambers 7a, 7b, 7c and 7d is assigned its own (partial) build platform and if simultaneous exposure of the different compositions takes place in the different process chambers 7a, 7b, 7c and 7d, the individual curing processes in the different process chambers 7a, 7b, 7c and 7d can run in parallel.

FIG. 3 shows a top view of the pressure trough 6 with the pressure trough 6 divided into process chambers 7a, 7b, 7c and 7d of equal size, each process chamber having its own exposure window (FIG. 3a) or the process chambers 7a, 7b, 7c and 7d sharing a large common window. If the radiation source 4 is placed below the pressure well bottom, it is a prerequisite in both cases that the pressure well bottom is permeable to radiation. In one embodiment, the pressure well bottom comprises—from bottom to top—a glass pane, a transparent silicone layer and a polymeric layer containing fluorocarbons. The transparent silicone layer and the fluorocarbon-containing polymeric layer make it easier to remove curable compositions after the additive manufacturing process is complete. The silicone layer simultaneously performs a sealing function of the individual process chambers 7a, 7b, 7c and 7d.

FIG. 4 shows the building platform 9 in each case laterally (top) and in plan view (bottom), whereby in FIG. 4a four punches are formed, whereby in FIG. 4b n punches are formed. The building platform 9 is segmented into punches 16, 16a, 16b, 16c. The number of punches can vary from n=2 to n=100 or n=200. Each individual punch is movable, i.e., displaceable from a defined zero position along its longitudinal axis. Each individual punch has a motor, actuator and/or gear drive and can be controlled, for example, by a microprocessor. A plurality of punches can form a matrix (see FIG. 4b), so that a matrix control takes place. Depending on the design of the process chambers 7a, 7b, 7c, groups of punches 16a, 16b, 16c can form (partial) building platforms 9 to which the forming part can attach. Thus, with the same exposure time, “printing processes” can run in parallel in the different process chambers 7a, 7b, 7c. Different curable compositions can be deposited in the different process chambers 7a, 7b, 7c, so that a device for simultaneous additive manufacturing of components made of different materials is provided.

### LIST OF REFERENCE SIGNS

1 Device
2. Shaped part
3, 3a, 3b, 3c curable compositions, in particular first second to n-th curable compositions
4 Radiation source
5 Basin module
6 Pressure trough/printing trough
7, 7a, 7b, 7c, 7d Process chambers
8 Reservoir
9 Building platform
10, 10a, 10b, 10c underside
11 Bottom
12 transparent bottom, especially plate or glass plate
13 Silicone(layer)
14 Polymeric layer containing fluorocarbon
15 Separating plate/partition wall
16, 16a, 16b, 16c Punch
17, 17a, 17b, 17c Front side

1. Device (1) for the layer-by-layer generative production of at least two three-dimensional shaped parts (2), each from at least one separate composition (3a, 3b) curable by means of radiation, comprising
at least one radiation source (4) and/or beam deflection device suitable for head-over-head impingement of the curable compositions (3) with beams, and
at least one pressure trough (6) having at least two process chambers (7) which are open at the top and are each suitable for receiving in each case one of the curable compositions (3), wherein the at least two process chambers (7) being arrangeable or are arranged above the radiation source (4) or a radiation deflection device, so that the curable compositions (3) are admittable by radiation from below in each of the different process chambers (7) via the radiation source (4) and/or the radiation deflection device, and
a building platform (9), in particular with an underside (10) exposable to radiation from the radiation source, suitable for bonding the respective shaped part (2) to be formed from the curable compositions (3) in the at least two open top process chambers,
wherein,
in that a bottom (11) of the at least one pressure trough (6) facing the radiation source (4) and/or radiation deflection device with the at least two process chambers (7) comprising at least partially a transparent material, wherein
the device (1) having a device for homogenizing of beam quantity distribution of the radiation source (4) and/or the beam quantity distribution of the beam deflection device, which device serving to produce a homogenized beam quantity distribution and has an arrangement of a two-dimensional radiating radiation source, an area light modulator and an optical system, in particular a lens system forms the optical system.

2. (canceled)

3. Device (1) according to claim 1, wherein the device (1) representing one for radiation curing, in particular for photopolymerization for the production of at least one three-dimensional shaped part per process chamber and/or that the device representing one for digital light processing of at least one three-dimensional shaped part per process chamber.

4. Device (1) according to claim 1, wherein the bottom (11) of the pressure trough (6) facing the radiation source (4) and/or radiation deflection device and having the at least two process chambers (7) is formed by at least one transparent
i) glass plate, the at least one glass plate optionally being provided on the surface of the at least one glass plate facing the at least two process chambers with a coating, a silicone layer and/or a film, or, a film optionally being arranged on the silicone layer, or
ii) polymer plate, wherein the at least one polymer plate is optionally provided with a coating, a silicone layer and/or a film on the surface of the at least one polymer plate facing the at least two process chambers, or, wherein a film is optionally arranged on the silicone layer, or
(iii) film, in particular at least one polymeric film, preferably a fluorine-containing polymeric film.

5. Device (1) according to claim 1, wherein the at least two process chambers (7) are separated from one another by at least one separating plate (15), the at least one separating plate (15) being at least partially coated with a fluorine-containing coating and/or silicone (13), in particular the walls of the pressure trough being coated on the inside with a fluorine-containing coating and/or silicone (13), so that the inner walls of the at least two process chambers each have a fluorine-containing coating and/or silicone layer (13).

6. Device (1) according to claim 1, wherein the at least one separating plate (15) is reversibly lockable in the pressure trough (6), in particular vertically arranged.

7. Device (1) according to claim 1, wherein the build platform (9) is segmented into punches (16), the punches (16) being movable, in particular along their longitudinal axis, in particular in the direction of the radiation source (4) and/or beam deflection device.

8. Device (1) according to claim 7, wherein each of the movable punches (16) is controllable individually by a processor or at least one group of punches (16) is controllable individually by a processor.

9. Device (1) according to claim 7, wherein each of the movable punches (16) has a motor, actuator and/or gear drive.

10. Device (1) according to claim 7, wherein a first group of punches (16a) are assignable to a first process chamber, a second group of punches (16b) are assignable to a second process chamber, and an n-th group of punches (16c) are assignable to an n-th process chamber.

11. Device (1) according to claim 10, wherein the first group of punches (16a) with their front sides facing the radiation source (4) and/or beam deflection device form a first underside (10a) of the building platform, the second group of punches (16b) with their front sides facing the radiation source (4) and/or beam deflection device form a second underside (10b) of the building platform, and the n-th group of punches with their front sides facing the radiation source (4) and/or beam deflection device form a n-th underside (10c) of the building platform, in particular
wherein the first group of punches with first underside (10a) is reversibly movable into the first process chamber, in particular vertically towards the bottom of the first process chamber (7a),
wherein the second group of punches with second underside (10b) is reversibly movable into the second process chamber (7b), in particular vertically towards the bottom of the second process chamber,
wherein the n-th group of punches with n-th underside (10c) is reversibly movable into the n-th process chamber (7c), in particular vertically towards the bottom of the n-th process chamber, wherein the first, second to n-th process chambers are arranged in the at least one pressure trough.

12. Device (1) according to claim 11, wherein the first group of punches (16a) with their first front side (17a) in the direction of the radiation source and/or radiation deflection device in the moved state on the first underside (10a) of the building platform span a first three-dimensional surface profile, wherein the second group of punches (16b) with their second front sides (17b) in the direction of the radiation source (4) and/or beam deflection device in the moved state span a second three-dimensional surface profile on the second underside (10b) of the building platform, and the n-th group of punches (16c) with their third front sides (17c) in the direction of the radiation source (4) and/or beam deflection device in the moved state on the third underside (10c) of the building platform span a third three-dimensional surface profile.

13. Device (1) according to claim 1, wherein the radiation source (4) is equipped with a projection unit, in particular based on DLP.

14. Device (1) according to claim 2, wherein the device for homogenizing the beam quantity distribution in the exposure field has an area light modulator which has a multiplicity of controllable tiltable micromirrors arranged in rows and columns, in which the rays of a radiation source (4) radiating in an area are imaged via an optical system and an exposure field of the imaged radiation source (4) is imaged on a projection surface, a number of pixels increasing towards the center of the exposure field not being exposed, so that in the time integral a homogenization of the ray intensity of all pixels exposed on the projection surface is achieved.

15. Method for producing at least one three-dimensional shaped part (2), in particular at least two three-dimensional shaped parts (2), from at least one separate composition curable by means of radiation in each case in an apparatus according to claim 1, comprising the steps:
A) Providing a device (1) with a pressure trough (6) with at least two process chambers (7a, 7b, 7c) open at the top, wherein the bottom (11) of the pressure trough (6) with the at least two process chambers (7) at least partially comprising a transparent material,
B) wherein at least one first process chamber of the at least two process chambers open at the top is filled with a first composition (3a) curable by means of radiation,
a) relative, in particular vertical, movement of the first underside (10a) of the build platform and a first underside of the first process chamber (7a) towards one another, so that the first underside or a first contact surface of at least one shaped part (2) attached to this underside forming shaped part (2) attached to this underside comes into contact with a first curable composition (3a) present in the first process chamber (7a) or is at least partially immersed in it, preferably the first underside or the first contact surface of the at least one forming shaped part is spaced apart from the first underside only by a defined layer of the first curable composition,
b) first curing a first layer on the first underside (10a) of the build platform or on the first contact surface of the at least one forming shaped part present first curable composition (3a) by means of head-over-head impact with beams through the first bottom comprising a transparent material of the first process chamber (7a),
c) relatively moving away from each other from the first underside (10a) and the bottom (11, 12, 13, 14) of the first process chamber (7a), in particular to wet a further contact surface of the at least one forming shaped part with the first curable composition (3a) present in the first process chamber (7a), preferably the further contact surface or the at least one shaped part is spaced from the first bottom only by a defined layer of the first curable composition,
d) repeating steps a) to c) until the at least one three-dimensional shaped part is completed; and
C) optionally, wherein at least one second process chamber of the at least two process chambers open at the top is filled with a second composition (3a) curable by means of radiation,
a) relative, in particular vertical, movement of the second underside (10b) of the building platform and a second bottom of the second process chamber (7b) towards each other, so that the second underside or a first contact surface of the at least one shaped part (2) attached to this underside forming shaped part (2) comes into contact with or is at least partially immersed in a second curable composition (3b) present in the second process chamber (7a), preferably the second underside or the first contact surface of the at least one shaped part is spaced apart from the second bottom only by a defined layer of the second curable composition,
b) first curing a first layer on the second underside (10b) of the build platform or on the first contact surface to the at least one forming shaped part present second curable composition (3b) by means of head-over-head impact with beams through the second bottom comprising a transparent material of the second process chamber (7b),
c) moving the second underside (10b) and the second bottom (11, 12, 13, 14) of the second process chamber (7b) relatively away from each other, in particular in order to wet a further contact surface of the at least one forming shaped part with the second curable composition (3b) present in the second process chamber (7b), preferably the further contact surface or the at least one shaped part is spaced apart from the second bottom only by a defined layer of the second curable composition,
d) Repeat steps a) through c) in C) until the at least one three-dimensional shaped part is completed.

16. The method according to claim 15, wherein the bottom (11) of the pressure trough (6) has as transparent material a fluorine-containing polymeric coating or a fluorine-containing polymeric film on the surface facing the at least two process chambers, in particular the fluorine-containing polymeric film is exchangeable.

17. Method according to claim 15 or 16, wherein the method B) comprises in step a) the step a2): Moving a first group of punches (16a) from a first underside (10a) of a build platform to a first position for forming a first three-dimensional surface profile by means of the first front sides (17a) of the first group of punches (16a) facing the radiation source (4), wherein initially the first underside (10a) faces the bottom of the first process chamber (7a).

18. Method according to claim 15, wherein the method comprises the step of: e) removing the shaped part (2) from the first underside (10a) of the build platform by moving the punches (16a) of the first group to a second position.

19. Method according to claim 16, wherein the step sequence a) to d) is repeated at least once, preferably n times, before continuing with step e).

20. A pressure trough for an apparatus according to claim 1, comprising at least two process chambers (7) open at the top, each suitable for receiving curable compositions (3), wherein the bottom (11) of the pressure trough (6) with the at least two process chambers (7) comprises at least partially a transparent material, in particular the bottom comprising transparent material a fluorine-containing polymeric coating or a fluorine-containing polymeric film on the surfaces facing the at least two process chambers.
